(19) United States
(12) Patent Application Publication
(10) Pub. No.: US 2004/0190376 A1
(43) Pub. Date: Sep. 30, 2004

(54) Sonar transducer

(76) Inventors: Jarl Hulden, Solna (SE); Thomas Bergovist, Stockholm (SE); Anders Haegermarck, Trangsund (SE); Bjorn Riise, Sollentuna (SE)

Correspondence Address: PEARNE & GORDON LLP, 1801 EAST 9TH STREET, SUITE 1200, CLEVELAND, OH, 44114-3108, US

(21) Appl. No.: 10/471,817

(22) PCT Filed: Mar. 7, 2002
(86) PCT No.: PCT/SE02/00421

(30) Foreign Application Priority Data
Mar. 15, 2001 (SE) 0100926-5

(51) Int. Cl. G01S 15/93

(52) U.S. Cl. 367/99

(57) ABSTRACT

An improved transducer for a proximity sensing system using a sonar transmitter is disclosed. An autonomous device provided with a number of motor-driven wheels further comprises a number of elements for the proximity navigation and guiding of the device such as a microprocessor system and a proximity ultrasonic sensing system comprising at least one transmitting member and one receiving member. The transmitting member is formed by the ultrasound transducer (11), which is positioned behind a wire mesh at the front of the device. The device transmits ultrasonic waves from a first strip-shaped device (21) with a narrow vertical distribution within a wide horizontal sector, and a second strip-shaped device (22) providing a wider vertical distribution within a similarly wide horizontal sector in front of the autonomous device. The proximity sensing system comprises a number of microphone units provided with hollow pipes for the sound and forming a input portion of a receiving system for receiving echoes of the transmitted ultrasonic waves reflected from objects in the forward course of the moving device. With this arrangement of transmitting and receiving, echoes from the floor or ground as well for instance sharp edged carpets or the like will be heavily suppressed. This then gibes a much more simplified detection of objects in the zone near to the device, where echoes from a floor or ground and the device itself become very strong.

### TECHNICAL FIELD

The present invention relates to an ultrasonic transducer element and assembly that can be effectively incorporated into the ultrasonic sensing system of a carrier for the purpose of detecting singularities or irregularities, such as obstacles or obstructions, in the carrier's field of operation that might interfere with the carrier's movements.

### BACKGROUND

For a number of years there had been an interest in developing autonomous carriers capable of treating the surfaces of fields of operation over which the carriers would traverse. There was a particular incentive for the development of an autonomous vacuum-cleaner which would be able to self-navigate about a room and perform a cleaning function according to a predetermined pattern, or strategy, while avoiding collisions with various obstacles in the room, including the walls.

Devices of the foregoing type have now been developed and are disclosed in the prior art. Two such devices are described in International Patent Applications WO 97/41451 (U.S. Pat. No. 5,935,179) and WO 00/38028. According to the prior art, generally, the autonomous apparatus consists of a main body supported on or by a number of motor driven wheels or rollers. A set of sensors for detecting obstacles and a navigation system, usually, are provided for the apparatus. A microprocessor, together with appropriate software, controls the operation of the device. The microprocessor receives input data from the sensors and the wheels. The input data from the wheels is used to establish the position or location of the device on the field of operation and the input data from the sensors is used to detect the locations of singularities or irregularities such as walls and potential obstacles which could interfere with the operation of the apparatus.

A property of the apparatus disclosed in International Patent Application WO97/41451 is that it has a somewhat limited obstacle-sensing range in certain elevated directions and, therefore, may fail to detect potential obstacles.

Consequently, it would be beneficial to provide an improved sensing system for autonomous surface-treatment devices, such as, for instance, devices for polishing or vacuuming surfaces, so that they may avoid collisions when performing their operations. It would be particularly advantageous to provide an improved sensing system that employs ultrasonic sensors.

### SUMMARY OF THE INVENTION

According to one aspect of the present invention, an improved ultrasonic transducer element and assembly are incorporated into a sensing system for an autonomous device, such as a vacuum-cleaner or dust-robot. The transducer assembly for the sensing system generates a wide pattern of ultrasonic waves with a high directiviy in the forward direction, resulting in a high sensitivity at the receiver that receives reflected ultrasound waves or echoes from potential obstacles or obstructions. At the same time, there results a wide sensitivity in a vertical forward direction for detecting obstacles that are located above the surface being vacuumed at a height at which the autonomous device could not pass under.

According to another aspect of the present invention, an autonomous device is provided with motor-driven wheels and systems for the navigation and guidance of the device and for the ultrasonic sensing of singularities or irregularities in the field of operation. A mechanical sensing element is provided on the device for actuating at least one contact sensor if the device physically contacts an obstacle in the course of its movements. The ultrasonic sensing system is located at the front of the device. The sensing system includes an ultrasonic transmitter or transducer assembly that generates ultrasonic wave patterns that will, effectively, enable obstacles or obstructions to be identified. The receiving elements of the sensing system comprise a number of microphone units for receiving echoes of the transmitted ultrasonic waves that are reflected from objects in front of and to the sides of the device. The microphone units can be provided with hollow pipes for enhancing the quality of the echoes.

In accordance with another aspect, the present invention provides an ultrasonic transducer assembly comprising two ultrasonic transducer elements. Each element is strip-shaped. That is to say that each element has an elongated configuration whereby the length of the element is a number of times greater than its width. One element, however, is wider than the other. In use, such as with an autonomous carrier, the elements are arranged parallel to one another with their lengths extending horizontally across the front of the carrier. The relationship between the length and width of the narrower element is such that the element, in use, is capable of generating both a wide horizontal distribution of ultrasonic waves and a wide vertical distribution of ultrasonic waves. The relationship between the length and width of the wider element is such that the element, in use, is capable of generating a wide horizontal distribution of ultrasonic waves and an elevated, narrow vertical distribution of ultrasonic waves.

According to another aspect, each ultrasonic transducer element comprises a capacitive transducer formed of a membrane and a first layer of an electrically-conductive material underlying but supported away from the membrane so as to establish an air gap between the membrane and the first layer of an electrically-conductive material. The membrane comprises a metal-covered dielectric film.

In accordance with yet another aspect, each ultrasonic transducer element includes a dielectric base layer directly underlying the first layer of an electrically-conductive material. The base layer also directly overlies a second layer of an electrically-conductive material, and a dielectric layer directly underlies the second layer of an electrically-conductive material.

According to still another aspect, the ultrasonic transducer assembly, as described, forms part of a sensing system for a carrier having motive means for moving the carrier over a field of operation. The sensing system senses singularities or irregularities in the field of operation. The ultrasonic transducer elements that constitute the ultrasonic transducer assembly are of such a length that, when they are mounted on the carrier, they extend across, substantially, the entire front portion of the carrier.

In accordance with a further aspect, the sensing system includes units for receiving echoes that are created when the ultrasonic waves generated by the ultrasonic transducer elements are reflected from singularities or irregularities in the field of operation.

In accordance with still other aspects, the membrane and the metal covering the dielectric film that is a part of the membrane are of specified thicknesses. Further, the metal, preferably, is a corrosion-resistant metal such as gold, and the dielectric film, preferably, is polyethylene terephthalate.

According to a particular aspect, the carrier comprises an autonomous vacuum cleaner.

### DESCRIPTION OF THE DRAWINGS

The invention will be described in relation to a preferred embodiment with reference to the accompanying drawings, in which:

FIG. 1 is a three-dimensional top view of an embodiment comprising an autonomous vacuum-cleaning robot equipped according to the present invention;

FIG. 2 is a side view of the autonomous device shown in FIG. 1;

FIG. 3 is a front view of the autonomous device of FIG. 1 illustrating an ultrasonic transducer assembly and two rows of receiving sensors at the front of the device;

FIG. 4 illustrates the ultrasonic transducer assembly of the present invention;

FIG. 5 is an enlarged view of a horizontal cross-section of a transducer element forming a part of the transducer assembly of FIG. 4;

FIG. 6 is a simplified illustration of the transmitter driving and switching circuit for the transducer assembly of FIG. 4;

FIG. 7 is an illustration of the horizontal radiation patterns for each of the transducer elements of the transducer assembly of FIG. 4;

FIG. 8 is an illustration of the vertical radiation patterns for the wider transducer element of the transducer assembly of FIG. 4; and

FIG. 9 is an illustration of the vertical radiation patterns for the narrower transducer element of the transducer assembly of FIG. 4.

### DESCRIPTION OF AN ILLUSTRATIVE EMBODIMENT

General Features

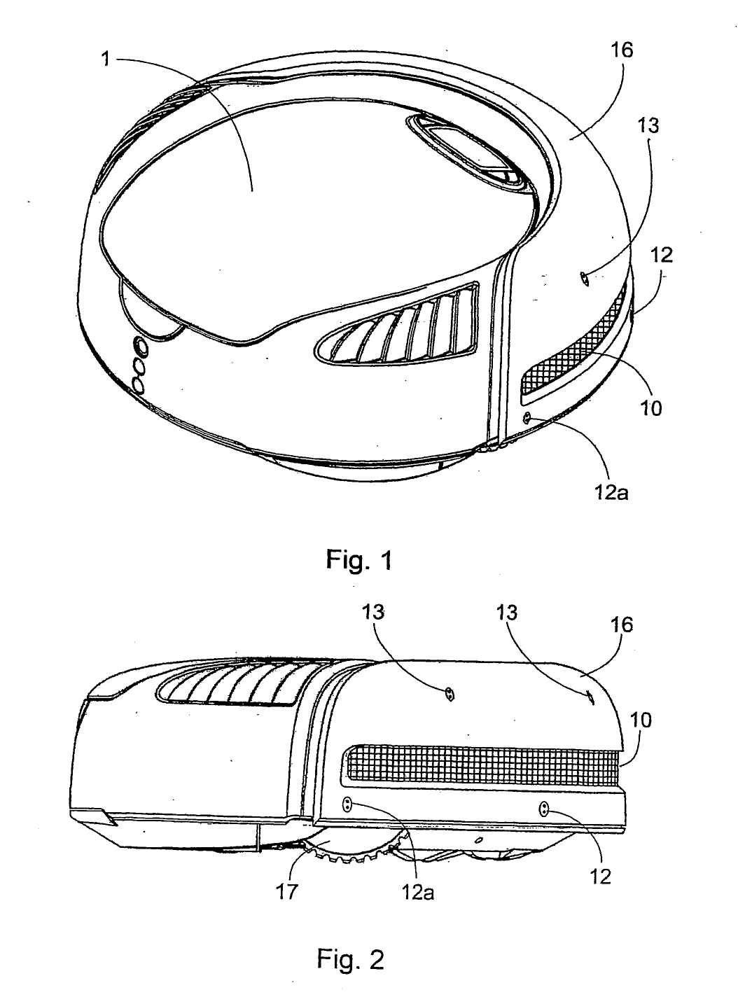

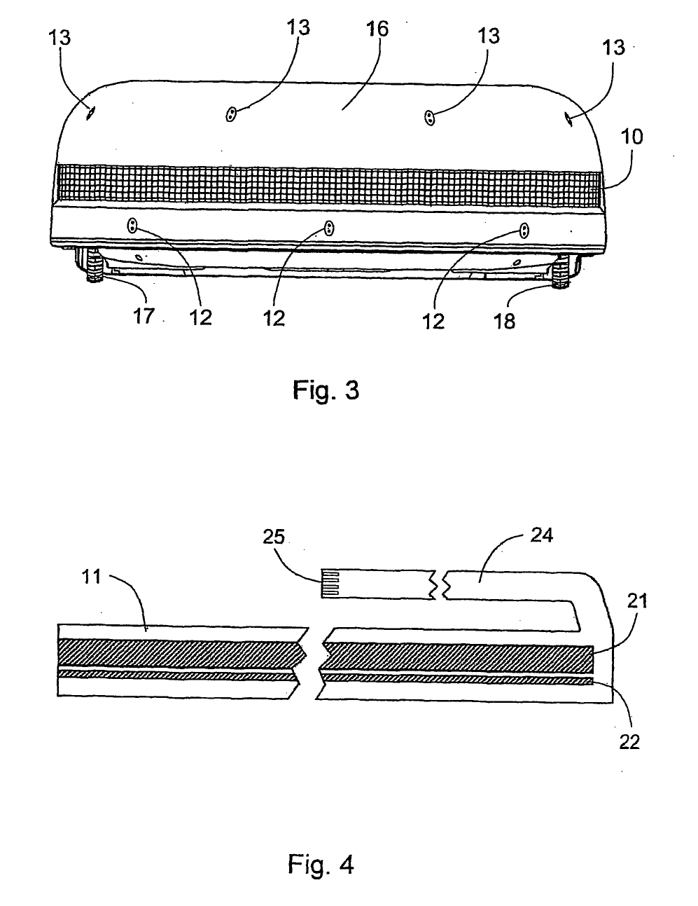

FIG. 1 is a three-dimensional top view an illustrative embodiment of an autonomous vacuum-cleaning device 1 according to the invention. The device, which, generally, is cylindrical-shaped, will move over a floor and vacuum-clean a room under its own power. At the front of the device there is arranged an ultrasonic transmitter 10. As best seen in FIGS. 2 and 3, the transmitter extends, essentially, over one-half, or 180 degrees, of the perimeter of the device at its front. As seen in FIG. 3, the transmitter 10 is mounted above a lower first row of microphone units 12 and below an upper second row of microphone units 13. The microphone units 12 and 13, together with the transmitter 10 form an ultrasonic sensing system for sensing obstacles and obstructions, thereby aiding in the navigation of the device. Thus, ultrasonic waves are emitted by the transmitter and, upon striking a singularity or irregularity, such as an obstacle or obstruction, are reflected back to the device 1. These echo waves are received by the microphones 12 and 13, and the location of the obstacle or obstruction is identified.

In the illustrated embodiment, the transmitter 10 is countersunk in a movable bumper unit 16 at the front of the device. The bumper 16 controls left and right physical contact sensors, 12a, which are actuated if the bumper comes into physical contact with an obstacle.

As best seen in FIGS. 2 and 3, the device has two diametrically opposed wheels 17 and 18 that act as motive means for the device. The wheels are independently driven by separate motors, preferably, equipped with gearboxes. The driven wheels 17 and 18 enable the device to rotate around its center of symmetry or around either wheel. On the axle or shaft from each motor, driving a respective wheel 17 or 18, a quadrature sensor is mounted. Quadrature signals from the sensors are received by a built-in microprocessor controlling the device. The signals from these sensors, or equivalent devices, are used for obtaining a dead count for determining the distance the wheel has traveled.

Optional wheels can be provided to support the rear of the device. The device is generally balanced with a slightly larger weight on its rear half which carries, for instance, the batteries for driving the motors for the wheels 17 and 18. As a result, the device is more likely to move with all its wheels in contact with the surface over which it traverses and it will easily pass over the edges of floor carpets and the like.

Ultrasound Transducer.

In FIG. 4 is illustrated an embodiment of the ultrasonic transducer assembly used for the transmitter 10. The assembly comprises two elongated or strip-shaped ultrasonic transducer elements 21 and 22 mounted on a base material 11. Each of the elements is of a length which is a number of times greater than its width and each element extends across the entire front of the transmitter 10 behind the transmitter's wire mesh opening. The base 11 includes a portion 24 that is provided with a connector 25 for the electrical leads of the transducer elements 21 and 22.

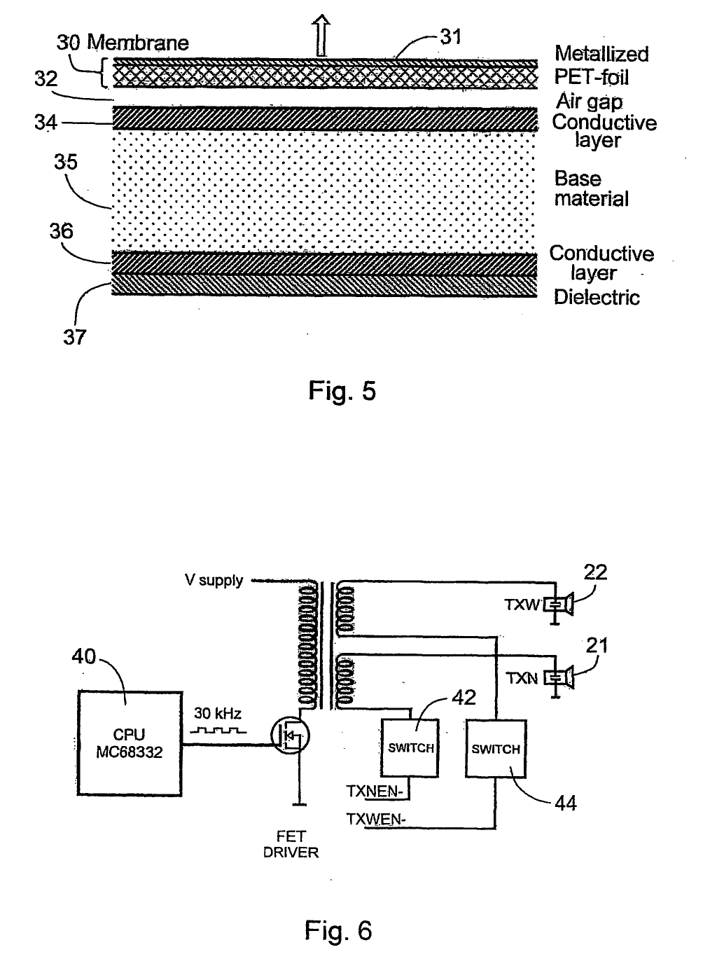

FIG. 5 is a partial horizontal cross section through one of the two transducer elements 21 and 22 and, because the elements are alike, is illustrative of the construction of both elements. The arrow in FIG. 5 indicates the direction in which the ultrasonic waves are transmitted. Each ultrasonic transducer element consists of a thin membrane 30 of a metal-covered dielectric film such as polyethylene terephthalate (PET) or the like. The PET film, or foil, carries the metallic layer 31 in front of a thin air gap 32. The air gap separates the membrane 30 from a first electrically-conductive layer 34 underlying the membrane. Directly underlying the layer 34 is a base layer of a dielectric 35 and directly underlying the layer 35 is a second electrically-conductive layer 36. The layer 36 acts as a screen for the back of the transducer elements. The second electrically-conducting layer 36 is directly underlain by an insulating dielectric layer 37. The electrically-conductive layers 31 and 34, together with the PET film of the membrane 30 and the air gap 32, form a capacitive transducer. The membrane 30, preferably, should not be thicker than about five micrometers and the metallic layer 31 should be corrosion-resistant. In a preferred embodiment the metallic layer 31 is gold of a thickness between about five and 100 nanometers. The very thin air gap 32 is of great importance for the satisfactory performance of the transducer and is best created by providing the layer 34 with a suitable roughness on its surface that faces the PET film.

The ultrasonic transducer elements 21 and 22 are energized by a generator that is controlled by a microprocessor. FIG. 6 is a simplified diagram of an embodiment of the generator. In the embodiment of FIG. 6, a Motorola MC68332 processor, or CPU 40, is utilized, but other integrated low power microprocessors may be used by suitably modifying the software of the autonomous device. The CPU delivers a set of square pulses, at a frequency of 30 kHz, to a driver consisting of a field effect transistor (FET driver). The drain of the field effect transistor has its voltage supplied by the primary winding of a transformer having two secondary windings connected to respective ultrasonic elements 21 and 22. The drive signal for the ultrasonic elements is doubled to a 60 kHz signal since the transducer elements are rectifying. Thus, the generated sound will be twice the frequency of the input signal. In the illustrated embodiment, the signal consists of three periods of a 30 kHz signal with a duty cycle of 40% controlled by a Time Processor Unit (TPU) in the microprocessor. The TPU runs in a mode referred to as Queued Output Mode (QOM). The microprocessor 40 will connect to ground either the control signal TXNEN—for switch 42 of element 21, TXN, for the generation of a narrow vertical transmission, or the control signal TXWEN—for switch 44 of element 22, TXW, for the generation of a wide vertical transmission. By changing the programming of the QOM parameters, the duty cycle and the number of pulses in a transmitted burst can be varied.

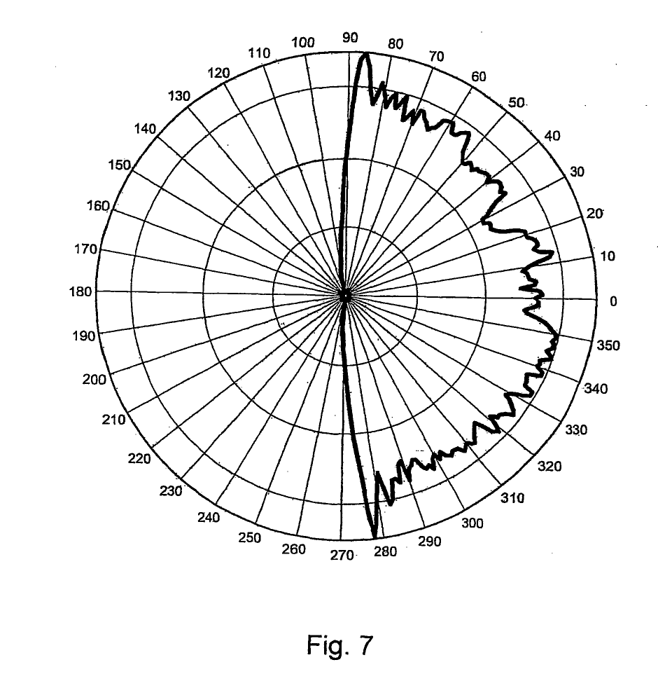

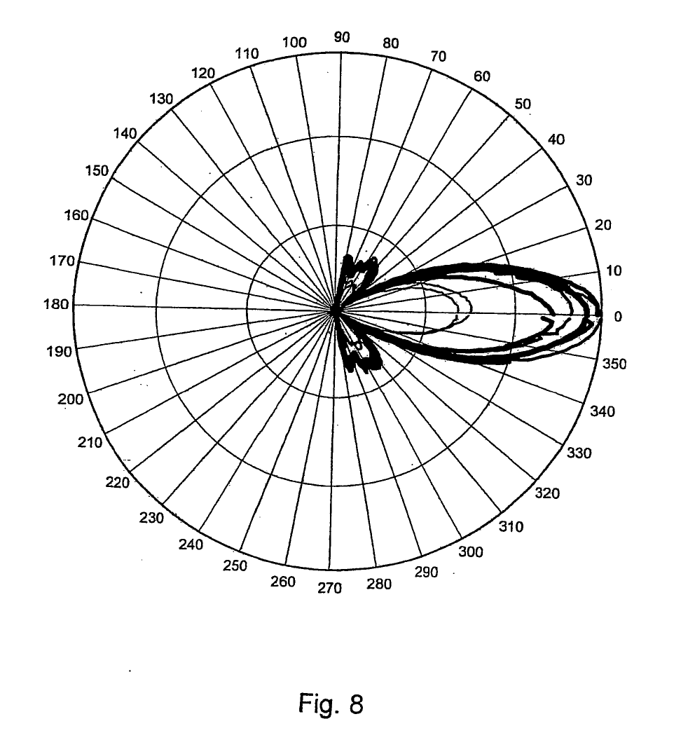

The elongated shape of the transducer elements results in the generation of a beam pattern with a wide horizontal distribution. FIG. 7 is a diagram that illustrates the horizontal distribution of the ultrasonic waves from either transducer element. The narrower and the wider strips have similar horizontal distribution patterns. FIG. 8 illustrates the vertical distribution pattern of the ultrasonic waves transmitted from the wider transducer element. The reason for the compressed lobe is that the wider strip acts as a vertical array of transmitter elements. The different-sized lobes in the diagram of FIG. 8 show the vertical lobe at different horizontal angles from the central forward direction of the transmitter 10 at directions perpendicular to the transmitter.

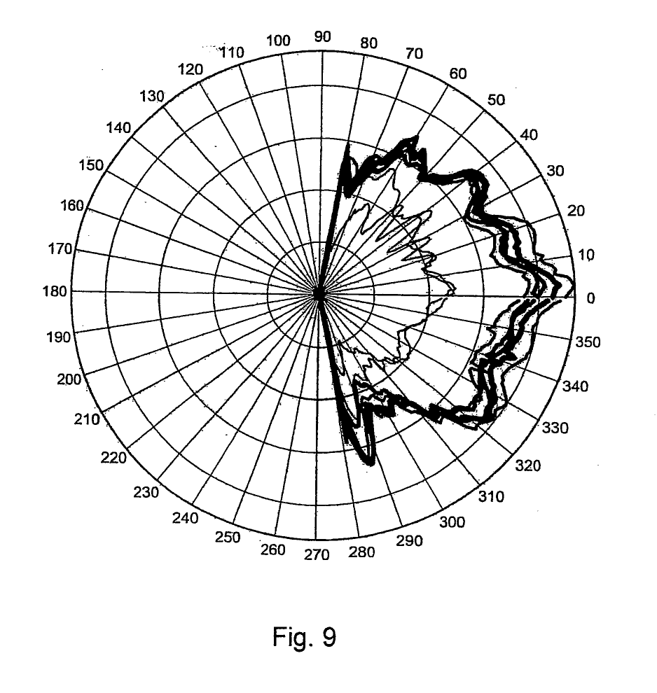

FIG. 9 is an illustration of the vertical beam patterns for the narrower transducer element. The maximum forward power output will be lower for the narrower strip producing the wider vertical pattern distribution illustrated. In other words, the beam radiation pattern of FIG. 9 is suitable for near-field sensing with both the lower and upper rows of microphones 12 and 13, while the beam radiation pattern of FIG. 8 is excellent for sensing more distant obstacles using, mainly, the lower row of microphones 12.

Microphones for detecting echoes from the ultrasonic waves transmitted by the transducer may, typically, be Electret Condenser microphones. The receptivity of a naked microphone is, essentially, omnidirectional. Therefore, the microphones are positioned behind a device containing a pair of vertical soundpipes which will allow a desired directivity to be obtained. With this arrangement of transmitting and receiving, echoes from the surface over which the device traverses, will be heavily suppressed. This allows for a less confusing detection of objects in the area near the device, where echoes from a carpet, floor or ground, or the device itself, are strongest.

It will be obvious to a person skilled in the art that the invention as specifically described may be modified and changed in various ways without departing from the scope of the invention as defined by the appended claims.

1. An ultrasonic transducer assembly comprising two ultrasonic transducer elements, each element having an elongated configuration whereby the length of the element is a number of times greater than its width, one element being narrower than the other, the elements when in use being arranged parallel to one another with their lengths extending horizontally, the relationship between the length and width of the narrower element being such that the element is capable of generating both a wide horizontal distribution of ultrasonic waves and a wide vertical distribution of ultrasonic waves in use, and the relationship between the length and width of the wider element being such that the element is capable of generating a wide horizontal distribution of ultrasonic waves and an elevated, narrow vertical distribution of ultrasonic waves in use.

2. The ultrasonic transducer assembly of claim 1 wherein each ultrasonic transducer element comprises a capacitive transducer formed of a membrane, comprising a metal-covered dielectric film, and a first layer of an electrically-conductive material underlying, but supported away from, the membrane so as to establish an air gap between the membrane and the first layer of an electrically-conductive material.

3. The ultrasonic transducer assembly of claim 2 wherein the membrane has a thickness of about five micrometers or less.

4. The ultrasonic transducer assembly of claim 3 wherein the metal covering the dielectric film has a thickness of about five to 100 nanometers.

5. The ultrasonic transducer assembly of claim 4 wherein the metal covering the dielectric film is resistant to corrosion.

6. The ultrasonic transducer assembly of claim 5 wherein the metal covering the dielectric film is gold and the dielectric film is polyethylene terephthalate.

7. The ultrasonic transducer assembly of claim 2 wherein each ultrasonic transducer element includes a dielectric base layer directly underlying the first layer of an electrically-conductive material and directly overlying a second layer of an electrically-conductive material, and a dielectric layer directly underlying the second layer of an electrically-conductive material.

8. The ultrasonic transducer assembly of claim 7 wherein the membrane has a thickness of about five micrometers or less.

9. The ultrasonic transducer assembly of claim 8 wherein the metal covering the dielectric film has a thickness of about five to 100 nanometers.

10. The ultrasonic transducer assembly of claim 9 wherein the metal covering the dielectric film is resistant to corrosion.

11. The ultrasonic transducer assembly of claim 10 wherein the metal covering the dielectric film is gold and the dielectric film is polyethylene terephthalate.

12. A carrier having motive means for moving over a field of operation and a system for sensing singularities in the field of operation, the sensing system including two ultrasonic transducer elements, each element having an elongated configuration whereby the length of the element is a number of times greater than its width, one element being narrower than the other, the elements being mounted on the front of the carrier parallel to one another and being of a length so as to extend across substantially the entire front portion of the carrier, the relationship between the length and width of the narrower element being such that the element is capable of generating both a wide horizontal distribution of ultrasonic waves and a wide vertical distribution of ultrasonic waves, and the relationship between the length and width of the wider element being such that the element is capable of generating a wide horizontal distribution of ultrasonic waves and an elevated, narrow vertical distribution of ultrasonic waves.

13. The carrier of claim 12 wherein the sensing system includes units for receiving echoes caused by reflections from singularities in the field of operation of the ultrasonic waves generated by the ultrasonic transducer elements.

14. The carrier of claim 13 wherein the units for receiving echoes are located both above and below the two ultrasonic transducer elements.

15. The carrier of claim 14 wherein selected units for receiving echoes are located below and adjacent the ends of the ultrasonic transducer elements, whereby the selected units may receive echoes from singularities located laterally of the carrier.

16. The carrier of claim 15 wherein the units for receiving echoes comprise ultrasonic microphones provided with vertical soundpipes to enhance the directivity of the echoes.

17. The carrier of claim 16 wherein the sensing system is capable of operating in an ultrasonic frequency range of approximately 60 kH_{Z}.

18. The carrier of claim 12 wherein each ultrasonic transducer element comprises a capacitive transducer formed of a membrane, comprising a metal-covered dielectric film, and a first layer of an electrically-conductive material underlying, but supported away from, the membrane so as to establish an air gap between the membrane and the first layer of an electrically-conductive material.

19. The carrier of claim 18 wherein the membrane has a thickness of about five micrometers or less.

20. The carrier of claim 19 wherein the metal covering the dielectric film has a thickness of about five to 100 nanometers.

21. The carrier of claim 20 wherein the metal covering the dielectric film is resistant to corrosion.

22. The carrier of claim 21 wherein the metal covering the dielectric film is gold and the dielectric film is polyethylene terephthalate.

23. The carrier of claim 18 wherein each ultrasonic element includes a dielectric base layer directly underlying the first layer of an electrically-conductive material and directly overlying a second layer of an electrically-conductive material, and a dielectric layer directly underlying the second layer of an electrically-conductive material.

24. The carrier of claim 23 wherein the membrane has a thickness of about five micrometers or less.

25. The carrier of claim 24 wherein the metal covering the dielectric film has a thickness of about five to 100 nanometers.

26. The carrier of claim 25 wherein the metal covering the dielectric film is resistant to corrosion.

27. The carrier of claim 26 wherein the metal covering the dielectric film is gold and the dielectric film is polyethylene terephthalate.

28. The carrier of claim 13 including means for operating the carrier autonomously and means for treating the surface of the field of operation.

29. The carrier of claim 28 wherein the treating means comprises vacuum-cleaning elements.

30. An ultrasonic transducer element comprising a capacitive transducer formed of a membrane, comprising a metal-covered dielectric film, and a first layer of an electrically-conductive material underlying, but supported away from, the membrane so as to establish an air gap between the membrane and the first layer of an electrically-conductive material.

31. The ultrasonic transducer element of claim 30 wherein the membrane has a thickness of about five micrometers or less.

32. The ultrasonic transducer element of claim 31 wherein the metal covering the dielectric film has a thickness of about five to 100 nanometers.

33. The ultrasonic transducer element of claim 32 wherein the metal covering the dielectric film is resistant to corrosion.

34. The ultrasonic transducer element of claim 33 wherein the metal covering the dielectric film is gold and the dielectric film is polyethylene terephthalate.

35. The ultrasonic transducer element of claim 30 including a dielectric base layer directly underlying the first layer of an electrically-conductive material and directly overlying a second layer of an electrically-conductive material, and a dielectric layer directly underlying the second layer of an electrically-conductive material.

36. The ultrasonic transducer element of claim 35 wherein the membrane has a thickness of about five micrometers or less.

37. The ultrasonic transducer element of claim 36 wherein the metal covering the dielectric film has a thickness of about five to 100 nanometers.

38. The ultrasonic transducer element of claim 37 wherein the metal covering the dielectric film is resistant to corrosion.

39. The ultrasonic transducer element of claim 38 wherein the metal covering the dielectric film is gold and the dielectric film is polyethylene terephthalate.
